(19) United States
(12) Patent Application Publication
(10) Pub. No.: US 2012/0147521 A1
(43) Pub. Date: Jun. 14, 2012

(54) CONDUCTIVE PASTE COMPOSITION FOR INNER ELECTRODE, MANUFACTURING METHOD THEREOF, AND MULTILAYER CERAMIC ELECTRONIC COMPONENT USING THE SAME

(75) Inventors: Joon Hee KIM, Hwaseong (KR); Jong Han Kim, Yongin (KR)

(73) Assignee: SAMSUNG ELECTRO-MECHANICS CO., LTD.

(21) Appl. No.: 13/051,495

(22) Filed: Mar. 18, 2011

(30) Foreign Application Priority Data
Dec. 10, 2010 (KR) 10-2010-0126244

(51) Int. Cl. H01G 4/12; H01B 1/22

(52) U.S. Cl. 361/321.2; 252/512; 252/513; 252/514

(57) ABSTRACT

There are provided a conductive paste composition for an inner electrode, a manufacturing method thereof, and a multilayer ceramic electronic component using the same. The method of manufacturing the conductive paste composition for the inner electrode includes: preparing a metal powder in which a cellulose-based resin is coated on the surfaces of metal particles by dispersing the metal powder within the cellulose-based resin; preparing a ceramic powder in which a polyvinyl butyral resin is coated on the surfaces of ceramic particles by dispersing the ceramic powder within the polyvinyl butyral resin; and mixing the metal powder and the ceramic powder. The conductive paste composition for the inner electrode has excellent dispersibility, thereby allowing for the formation of a thin inner electrode layer.

### CROSS-REFERENCE TO RELATED APPLICATIONS

This application claims the priority of Korean Patent Application No. 10-2010-0126244 filed on Dec. 10, 2010, in the Korean Intellectual Property Office, the disclosure of which is incorporated herein by reference.

### BACKGROUND OF THE INVENTION

1. Field of the Invention

The present invention relates to a conductive paste composition for an inner electrode layer having excellent dispersibility and capable of forming a thin inner electrode layer, a manufacturing method thereof, and a multilayer ceramic electronic component using the same.

2. Description of the Related Art

Recently, with high-performance, and thin-layer and small-size tendencies in electric and electronic apparatus industries, electronic components having characteristics such as a small size, high performance, and a low cost are remarkably required.

In particular, as high-speed CPUs and small-size, light-weight, digitalized, and high-functional devices have been more widely used, R&D into a multilayer ceramic capacitor having characteristics such as a small size, a thin layer, high capacity, low impedance in a high frequency region has been actively performed in response to the requirements.

Since a metallic paste for an internal electrode which is a core raw material of a high-capacity multilayer ceramic capacitor is applied to a thin-layer dielectric sheet, an aggregate is generated due to a dispersion error when the paste is not uniformly dispersed, and as a result, shorts may be generated and reliability deteriorated. Accordingly, a high dispersed metallic paste is required.

Meanwhile, with the high capacity of the multilayer ceramic capacitor, the internal electrode is required to be thin.

However, since the metallic paste for the internal electrode manufactured by the existing method is low in surface roughness and dispersibility, the internal electrode may be easily aggregated and the thickness thereof may not be uniform after firing, and accordingly, it is difficult to thin the internal electrode.

### SUMMARY OF THE INVENTION

An aspect of the present invention provides a conductive paste composition for an inner electrode layer having excellent dispersibility and capable of forming a thin inner electrode layer, a manufacturing method thereof, and a multilayer ceramic electronic component using the same.

According an aspect of the present invention, there is provided a method of manufacturing a conductive paste composition for an inner electrode, the method including: preparing a metal powder in which a cellulose-based resin is coated on surfaces of metal particles by dispersing the metal powder within the cellulose-based resin; preparing a ceramic powder in which a polyvinyl butyral resin is coated on surfaces of ceramic particles by dispersing the ceramic powder within the polyvinyl butyral resin; and mixing the metal powder and the ceramic powder.

The cellulose-based resin may be ethyl cellulose.

The metal powder may be one of silver (Ag), lead (Pb), platinum (Pt), nickel (Ni), and copper (Cu).

The metal powder may be dispersed by a 3-roll mill.

The metal powder may have an average particle-size of 50 nm to 400 nm.

The ceramic powder may be one of BaTiO₃, Ba(TiZr)O₃, CaZrO₃, and SrZrO₃.

The ceramic powder may be dispersed by a beads mill.

The ceramic powder may have an average particle-size of 10 nm to 200 nm.

The method for fabricating the conductive paste composition for the inner electrode may further include dispersing a mixture of the metal powder and the ceramic powder by a 3-roll mill.

According to anther aspect of the present invention, there is provided a conductive paste composition for an inner electrode including: a metal powder having a cellulose-based resin coated on surfaces of metal particles thereof; and a ceramic powder having a polyvinyl butyral resin coated on surfaces of ceramic particles thereof.

According to another aspect of the present invention, there is provided a multilayer ceramic electronic component including: a ceramic sintered body having dielectric layers stacked therein; inner electrode layers formed on the dielectric layers and formed of a conductive paste composition for inner electrodes including a metal powder having a cellulose-based resin coated on surfaces of metal particles and a ceramic powder having a polyvinyl butyral resin coated on surfaces of ceramic particles; and outer electrodes formed outwardly of the ceramic sintered body and electrically connected with the inner electrode layers.

Each of the dielectric layers may have a thickness of 1.0 to 6.0 μm and each of the inner electrode layers may have a thickness of 1.0 μm or less.

A coverage of the inner electrode layers may be 80% or more and a connectivity of the inner electrode layers may be 90% or more.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a flowchart illustrating manufacturing processes of a conductive paste composition for an inner electrode according to an exemplary embodiment of the present invention;

FIG. 2 is a diagram illustrating manufacturing processes of a conductive paste composition for an inner electrode according to an exemplary embodiment of the present invention;

FIG. 3 is a schematic perspective view illustrating a multilayer ceramic capacitor according to an exemplary embodiment of the present invention;

FIG. 4 is a cross-sectional view taken along line A-A′ of FIG. 3;

FIGS. 5A and 5B compare a printed image of a multilayer ceramic capacitor 5B according to an exemplary embodiment of the present invention with that of a multilayer ceramic capacitor 5A according to the related art;

FIGS. 6A and 6B compare delamination of a multilayer ceramic capacitor 6B according to an exemplary embodiment of the present invention with that of a multilayer ceramic capacitor 6A according to the related art;

FIGS. 7A and 7B compare electrode coverage of a multilayer ceramic capacitor 7B according to an exemplary embodiment of the present invention with that of a multilayer ceramic capacitor 7A according to the related art; and

FIGS. 8A and 8B compare inner electrode connectivity of a multilayer ceramic capacitor 8B according to an exemplary embodiment of the present invention with that of a multilayer ceramic capacitor 8A according to the related art.

### DETAILED DESCRIPTION OF THE PREFERRED EMBODIMENT

Hereinafter, exemplary embodiments of the present invention will be described in detail with reference to the accompanying drawings.

However, the exemplary embodiments of the present invention may be modified in various forms and the scope of the present invention is not limited to the exemplary embodiments described below. Exemplary embodiments of the present invention are provided so that those skilled in the art may more completely understand the present invention. Accordingly, the shapes and sizes of elements in the drawings may be exaggerated for clear description and like reference numerals refer to like elements throughout the drawings.

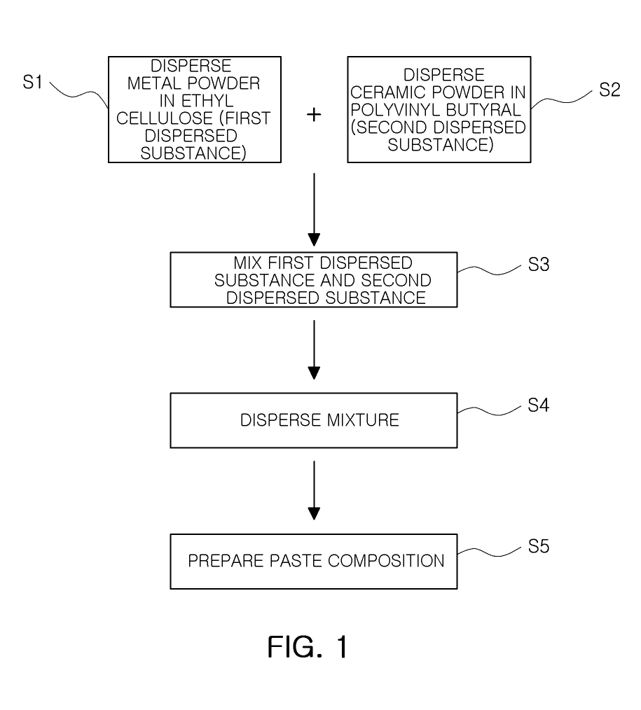

FIG. 1 is a flowchart illustrating manufacturing processes of a conductive paste composition for an inner electrode according to an exemplary embodiment of the present invention.

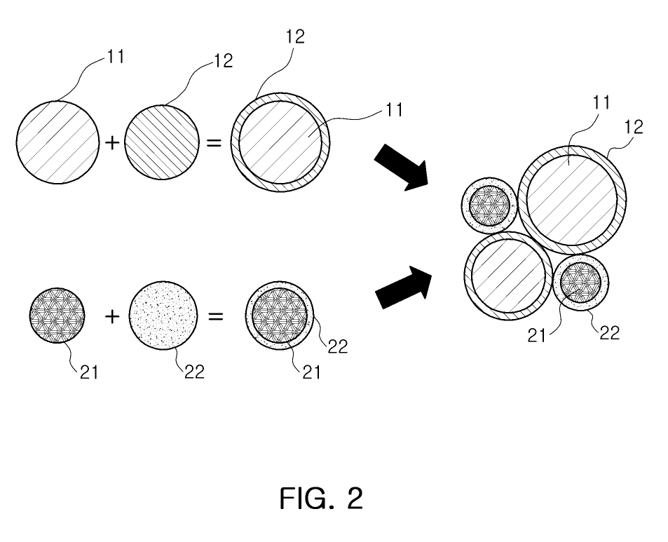

FIG. 2 is a diagram illustrating manufacturing processes of a conductive paste composition for an inner electrode according to an exemplary embodiment of the present invention.

As shown in FIG. 1, a method of manufacturing a conductive paste composition for an inner electrode according to an exemplary embodiment of the present invention includes preparing a metal powder in which a cellulose-based resin is coated on the surfaces of metal particles by dispersing the metal powder within the cellulose-based resin (S1); preparing a ceramic powder in which a polyvinyl butyral resin is coated on the surfaces of ceramic particles by dispersing the ceramic powder within the polyvinyl butyral resin (S2); mixing the metal powder and the ceramic powder (S3); dispersing the mixture (S4); and preparing a conductive paste composition for an inner electrode (S5).

The exemplary embodiment of the present invention provides the method of manufacturing the conductive paste composition for the inner electrode in which the metal powder and the ceramic powder each is separately dispersed and then mixed and dispersed, such that the ceramic powder is evenly dispersed in the metal powder.

Particularly, in the exemplary embodiment of the present invention, the metal powder is dispersed within the cellulous resin and the ceramic powder is dispersed within the polyvinyl butyral resin, thereby improving the dispersibility of the paste composition.

The resin added in the dispersing process has a very important role determining the characteristics of the paste.

That is, in the dispersing process of the paste, the resin acts as a dispersant and provides flowability and phase stability to the paste.

In addition, in order to fabricate the multilayer ceramic capacitor, the resin acts to flatten a printed surface of the paste through a viscoelastic behavior of the resin in a process of printing the paste on a ceramic green sheet.

Next, the resin acts as an adhesive providing adhesive strength between a dielectric layer and an inner electrode layer in a process of laminating a plurality of green sheets on which the paste is printed.

Hereinafter, a method of a conductive paste composition for an inner electrode according to an exemplary embodiment of the present invention will be particularly described.

First, the metal powder having the cellulose-based resin coated on the surface of the metal particle is prepared by dispersing the metal powder within the cellulose-based resin (S1).

The cellulose-based resin is not particularly limited and may be, for example, ethyl cellulose.

An ethyl cellulose resin having a chair type structure has a fast resilient characteristic due to elasticity when deformation due to a dispersing stress is generated.

Accordingly, a flat paste-printed surface can be ensured.

In addition, since the ethyl cellulous resin may be advantageously dispersed due to a high affinity with the metal powder, in the exemplary embodiment of the present invention, the metal powder coated with the cellulous-based resin is prepared by dispersing the metal powder within the cellulose-based resin, particularly, the ethyl cellulose resin.

The metal powder is not particularly limited and may be, for example, silver (Ag), lead (Pb), platinum (Pt), nickel (Ni), copper (Cu), or the like, all of which may be used in the form of a single component or a mixture of two or more components.

In addition, the metal powder has various particle sizes according to exemplary embodiments of the present invention and may have a particle-size of, for example, 50 nm to 400 nm.

When the particle size of the metal powder is less than 50 nm, the contraction of the metal powder is difficult to control during sintering, and when the particle size of the metal powder is more than 400 nm, it is difficult to form a thin inner electrode layer.

Meanwhile, the dispersing method of the metal powder is not particularly limited and may be performed by, for example, a 3-roll mill.

Next, the ceramic powder having the polyvinyl butyral resin coated on the surface of the ceramic particle is prepared by dispersing the ceramic powder within the polyvinyl butyral resin (S2).

Since the polyvinyl butyral resin having a structure consisting of chains and crosslinks has a chain-broken characteristic due to deformation by dispersing stress, elastic resilience is difficult to realize and a flat printed surface cannot be ensured.

However, the polyvinyl butyral resin has an advantage of a strong adhesion.

In addition, the ceramic powder may be dispersed within both the ethyl cellulose resin and the polyvinyl butyral resin, but the polyvinyl butyral resin having a low viscosity is more advantageous.

The ceramic powder is not particularly limited as long as it can be used to control the sintering contraction of the metal powder. For example, the ceramic powder may be at least one of BaTiO₃, Ba(TiZr)O₃, CaZrO₃, and SrZrO₃.

The dispersing method of the ceramic powder is not particularly limited and for example, may be dispersed by a beads mill.

The ceramic powder may have various particle-sizes according to exemplary embodiments of the present invention and may have, for example, an average particle-size of 10 nm to 200 nm.

The particle-size of the ceramic powder may be determined in proportion to the particle-size of the metal powder and may be 10 nm to 200 nm as described above.

The ethyl cellulose resin, used for printing in the manufacturing of a paste composition for an inner electrode, may be evenly printed on the paste due to the viscoelastic characteristic.

On the contrary, in the use of the polyvinyl butyral resin, it is difficult to ensure a flat printed surface, but the advantage of strong adhesion properties exists.

Accordingly, in the case in which any one of the resins is used, for example, in the case of using only the ethyl cellulose resin, the flat printed surface can be ensured, but the adhesion is weak; on the contrary, in the case of using only the polyvinyl butyral resin, the adhesion is strong, but the flat printed surface is difficult to be ensured.

Meanwhile, in the case in which the ethyl cellulose resin and the polyvinyl butyral resin are merely mixed, the adhesive properties thereof are improved, but the printed shape is non-uniform, and accordingly, it is difficult to manufacture a thin inner electrode.

In particular, since the ethyl cellulose resin and the polyvinyl butyral resin have largely different structures, they are not easily mixed and cohesion of the resins occurs.

According to the exemplary embodiment of the present invention, since the metal powder is dispersed within the cellulose-based resin and the ceramic powder is dispersed within the polyvinyl butyral resin so as to manufacture the paste, a flat printed surface without the cohesion of the resins, while achieving improved dispersibility and excellent adhesion, can be ensured.

Next, the metal powder and the ceramic powder are mixed (S3).

The metal powder is coated with the cellulose-based resin, particularly, the ethyl cellulose resin, and the ceramic powder is coated with the polyvinyl butyral resin.

As described above, since the metal powder and the ceramic powder are separately dispersed within the ethyl cellulose resin and the polyvinyl butyral resin, respectively, even in the case that the metal powder and the ceramic powder coated with the resins are mixed, the cohesion of the resins does not occur.

After mixing the metal powder and the ceramic powder, the mixture thereof is dispersed within the solvent (S4) and the conductive paste composition for the inner electrode according to the exemplary embodiment of the present invention is prepared (S5).

The dispersing method of the mixture is not particularly limited and may be performed, for example, by a 3-roll mill.

In addition, the conductive paste composition for the inner electrode is prepared by a general process, except for the mixing and dispersing processes of the metal powder and the ceramic powder.

The solvent included in the conductive paste composition for the inner electrode is not limited as long as it can be used to manufacture the paste.

That is, the solvent included in the conductive paste composition for the inner electrode may be, for example, terpineol, dihydroterpineol, butyl carbitol, kerosene, or the like.

As shown in FIG. 2, a conductive paste composition for an inner electrode according to an exemplary embodiment of the present invention includes a metal powder 11 coated with a cellulose-based resin 12; and a ceramic powder 21 coated with a polyvinyl butyral resin 22.

The conductive paste composition for the inner electrode may be manufactured by the method of manufacturing the conductive paste composition for the inner electrode according to the aforementioned embodiment of the present invention.

Accordingly, since the cellulose-based resin 12 is mostly coated on the metal powder 11 and the polyvinyl butyral resin 22 is coated on the ceramic powder 21, the cohesion between both resins does not occur, a flat printed surface having excellent dispersibility may be formed.

In addition, since the adhesion with a dielectric sheet is excellent, a delamination defect does not occur.

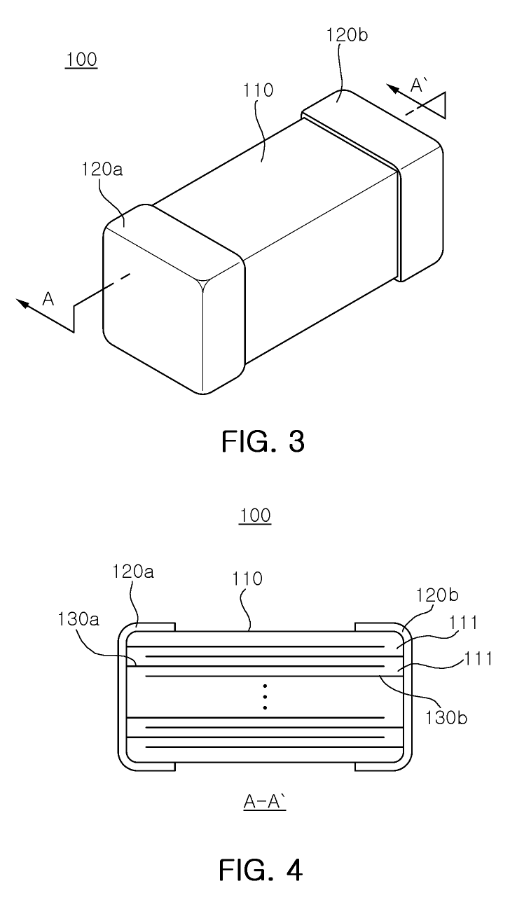

FIG. 3 is a schematic perspective view illustrating a multilayer ceramic capacitor according to an exemplary embodiment of the present invention, and FIG. 4 is a cross-sectional view taken along line A-A′ of FIG. 3.

Referring to FIGS. 3 and 4, a multilayer ceramic electronic component according to another exemplary embodiment of the present invention, particularly, a multilayer ceramic capacitor 100 includes a ceramic sintered body 110 having dielectric layers 111 stacked therein; inner electrode layers 130a and 130b formed on the dielectric layers 111 and formed of a conductive paste composition for inner electrodes, including a metal powder having a cellulose-based resin coated on the surfaces of metal particles and a ceramic powder having a polyvinyl butyral resin coated on the surfaces of ceramic particles; and outer electrodes 120a and 120b formed outwardly of the ceramic sintered body 110 and electrically connected with the inner electrode layers.

The ceramic sintered body 110 is formed by stacking the plurality of ceramic dielectric layers 111 and sintering them, in which adjacent dielectric layers are integrated.

The ceramic dielectric layer 111 may be made of a ceramic material having a high dielective constant and is not limited thereto. For example, barium titanate (BaTiO₃)-based material, a lead-complex perovskite-based material, strontium titanate (SrTiO₃)-based material, or the like may be used therefor.

The thickness of the dielectric layer may be adjusted according to exemplary embodiments of the present invention and for example, may be 1.0 to 6.0 μm.

The inner electrode layers 130a and 130b are formed between the dielectric layers during the stacking of the plurality of dielectric layers, and are formed in the ceramic sintered body 110 through a sintering process with the dielectric layer interposed therebetween.

Ends of the inner electrode layers 130a and 130b are alternately exposed to both ends of the ceramic sintered body 110.

The ends of the inner electrode layers 130a and 130b exposed to the ends of the ceramic sintered body 110 are electrically connected to the outer electrodes 120a and 120b, respectively.

The inner electrode layers 130a and 130b are formed of the paste composition for the inner electrode according to the exemplary embodiment of the present invention.

The thickness of the inner electrode layer may be adjusted according to exemplary embodiments of the present invention and for example, may be 1.0 μm or less.

The coverage of the inner electrode layers may be 80% or more and the connectivity of the inner electrode layers may be 90% or more.

The coverage of the inner electrode layers refers to the entire area of the inner electrode applied to the dielectric layers and the connectivity of the inner electrode layers refers to a ratio of the actual paste-applied area of an inner electrode to the entire area of the inner electrode.

Since the paste composition for the inner electrode according to the exemplary embodiment of the present invention has excellent dispersibility and allows for the formation of a flat printed surface, the inner electrode layer formed by using the same has the coverage of 80% or more as described above.

In addition, since the inner electrode connectivity is 90% or more, although the inner electrode is manufactured to be thin, an ultra-capacity multilayer ceramic electronic component ensuring the reliability can be fabricated.

The detailed components and characteristics of the paste composition for the inner electrode are the same as described above.

Since the paste composition for the inner electrode according to the exemplary embodiment of the present invention has excellent dispersibility and allows for the formation of a flat printed surface, the inner electrode layer formed by using the same has excellent adhesion with the dielectric sheet, so that a delamination defect does not occur.

In addition, the thin inner electrode can be formed.

The method of fabricating the multilayer ceramic electronic component according to the exemplary embodiment of the present invention is the same as a general method, except that the inner electrode layer is formed by using the paste composition for the inner electrode according to the exemplary embodiment of the present invention.

A method of fabricating a multilayer ceramic electronic component according to an exemplary embodiment of the present invention will be described below in detail.

First, a conductive paste composition for an inner electrode, which includes a metal powder coated with a cellulose-based resin and a ceramic powder coated with a polyvinyl butyral resin, is prepared.

Specifically, nickel (Ni) metal powder is dispersed in an ethyl cellulose resin by the 3-roll mill to thereby allow the ethyl cellulose resin to be coated on the surface of nickel particles, and separately, barium titanate (BaTiO₃) powder is dispersed in a polyvinyl butyral resin by a beads mill to thereby allow the polyvinyl butyral resin to be coated on the surfaces of barium titanate particles.

The nickel powder has a particle-size of 200 nm and the barium titanate powder has a particle-size of 50 nm.

Thereafter, the nickel powder and the barium titanate powder are mixed and dispersed by the 3-roll mill, thereby forming the conductive paste composition for the inner electrode.

In the process of fabricating the multilayer ceramic capacitor using the conductive paste, first, a plurality of green sheets are prepared by using the barium titanate (BaTiO₃) powder.

In addition, the paste is dispensed on the green sheet and a squeegee moves in a direction, thereby forming an inner electrode layer.

As such, after the inner electrode layer is formed and the green sheet is separated from a carrier film. Then, the plurality of green sheets are stacked upon each other to thereby form a stack.

Subsequently, after the green sheet stack is compressed at high temperature and high pressure, the compressed stack is cut to have a predetermined size through a cutting process, thereby forming a green chip.

Thereafter, plasticizing, firing, and polishing processes are performed to manufacture the ceramic sintered body and the formation of outer electrodes and a plating process are performed to thereby manufacture a multilayer ceramic capacitor.

The thickness of the inner electrode layer of the multilayer ceramic capacitor is 0.6 μm.

Meanwhile, the comparative example fabricated by a known method of fabricating a multilayer ceramic capacitor according to the related art is the same as the above-described inventive example, except that each of the nickel powder and the barium titanate powder is dispersed in a mixture in which the ethyl cellulose resin and the polyvinyl butyral resin are merely mixed.

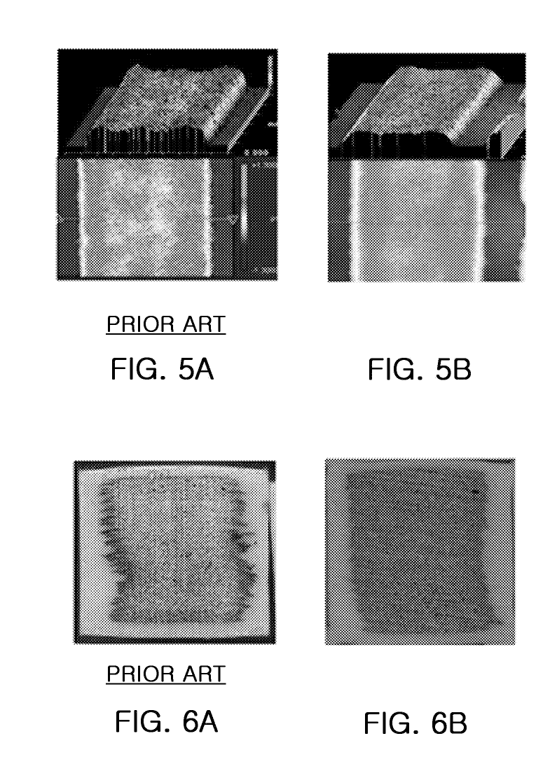

FIGS. 5A and 5B compare a printed image of a multilayer ceramic capacitor 5B according to an exemplary embodiment of the present invention with that of a multilayer ceramic capacitor 5A according to the related art.

FIGS. 6A and 6B compare delamination of a multilayer ceramic capacitor 6B according to an exemplary embodiment of the present invention with that of a multilayer ceramic capacitor 6A according to the related art.

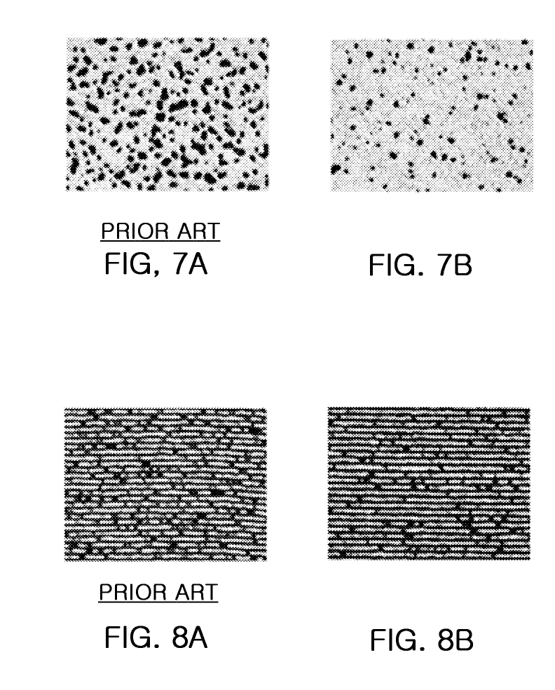

FIGS. 7A and 7B compare electrode coverage of a multilayer ceramic capacitor 7B according to an exemplary embodiment of the present invention with that of a multilayer ceramic capacitor 7A according to the related art.

FIGS. 8A and 8B compare inner electrode connectivity of a multilayer ceramic capacitor 8B according to an exemplary embodiment of the present invention with that of a multilayer ceramic capacitor 8A according to the related art.

Referring to FIGS. 5 to 8, as compared with the case in which the ethyl cellulose resin and the polyvinyl butyral resin are merely mixed, when the resins are separately used in the dispersing process according to the exemplary embodiment of the present invention, improved printed shape, reduced delamination, and improved inner electrode coverage and connectivity were achieved.

The following Table 1 shows the results of comparing the case in which the metal powder and the ceramic powder are dispersed in the mixture of the ethyl cellulose resin and the polyvinyl butyral resin (comparative example) and the case in which the metal powder and the ceramic powder are separately dispersed to be coated with the ethyl cellulose resin and the polyvinyl butyral resin, respectively (inventive example) in terms of delamination, inner electrode coverage and inner electrode connectivity.

TABLE 1

| | | Inner Electrode | Inner Electrode |
|---|---|---|---|
| Classification | Delamination | Coverage | Connectivity |
| Comparative | 30% or more | less than 75% | less than 85% |
| example | | | |
| Inventive | less than 5% | 80% or more | 90% or more |
| example | | | |

Referring to the Table 1, in the exemplary embodiment of the present invention, since the inner electrode layer is formed by using the conductive paste composition, the delamination defect between the inner electrode layer and the dielectric layer is decreased, so that the reliability of the multilayer ceramic capacitor is improved.

In particular, in the exemplary embodiment of the present invention, since the thin inner electrode can be manufactured so as to have the inner electrode coverage and connectivity of 80% or more and 90% or more, respectively, the ultra-capacity multilayer ceramic capacitor can be fabricated.

As set forth above, a conductive paste composition for an inner electrode layer according to exemplary embodiments of the invention has excellent adhesion and ensures fine and flat printed surfaces without the cohesion of resins.

In addition, a thin inner electrode layer can be formed due to excellent dispersibility so that an ultra-capacity ceramic electronic component can be manufactured.

While the present invention has been shown and described in connection with the exemplary embodiments, it will be apparent to those skilled in the art that modifications and variations can be made without departing from the spirit and scope of the invention as defined by the appended claims.

What is claimed is:

1. A method of fabricating a conductive paste composition for an inner electrode, the method comprising:
preparing a metal powder in which a cellulose-based resin is coated on surfaces of metal particles by dispersing the metal powder within the cellulose-based resin;
preparing a ceramic powder in which a polyvinyl butyral resin is coated on surfaces of ceramic particles by dispersing the ceramic powder within the polyvinyl butyral resin; and
mixing the metal powder and the ceramic powder.

2. The method of claim 1, wherein the cellulose-based resin is ethyl cellulose.

3. The method of claim 1, wherein the metal powder is at least one selected from the group consisting of silver (Ag), lead (Pb), platinum (Pt), nickel (Ni), and copper (Cu).

4. The method of claim 1, wherein the metal powder is dispersed by a 3-roll mill.

5. The method of claim 1, wherein the metal powder has an average particle-size of 50 nm to 400 nm.

6. The method of claim 1, wherein the ceramic powder is at least one selected from the group consisting of BaTiO₃, Ba(TiZr)O₃, CaZrO₃, and SrZrO₃.

7. The method of claim 1, wherein the ceramic powder is dispersed by a beads mill.

8. The method of claim 1, wherein the ceramic powder has an average particle-size of 10 nm to 200 nm.

9. The method of claim 1, further comprising dispersing a mixture of the metal powder and the ceramic powder by a 3-roll mill.

10. A conductive paste composition for an inner electrode comprising:
a metal powder having a cellulose-based resin coated on surfaces of metal particles thereof; and
a ceramic powder having a polyvinyl butyral resin coated on surfaces of ceramic particles thereof.

11. The conductive paste composition of claim 10, wherein the cellulose-based resin is ethyl cellulose.

12. A multilayer ceramic electronic component comprising:
a ceramic sintered body having dielectric layers stacked therein;
inner electrode layers formed on the dielectric layers and formed of a conductive paste composition for inner electrodes including a metal powder having a cellulose-based resin coated on surfaces of metal particles and a ceramic powder having a polyvinyl butyral resin coated on surfaces of ceramic particles; and
outer electrodes formed outwardly of the ceramic sintered body and electrically connected with the inner electrode layers.

13. The multilayer ceramic electronic component of claim 12, wherein each of the dielectric layers has a thickness of 1.0 to 6.0 μm.

14. The multilayer ceramic electronic component of claim 12, wherein each of the inner electrode layers has a thickness of 1.0 μm or less.

15. The multilayer ceramic electronic component of claim 12, wherein a coverage of the inner electrode layers is 80% or more.

16. The multilayer ceramic electronic component of claim 12, wherein a connectivity of the inner electrode layers is 90% or more.
